(19) United States
(12) Patent Application Publication
(10) Pub. No.: US 2026/0080260 A1
(43) Pub. Date: Mar. 19, 2026

(54) LARGE LANGUAGE MODELS FOR NL2SQL WITH LONG CONTEXT FINETUNING

(71) Applicant: Oracle International Corporation, Redwood Shores, CA (US)

(72) Inventors: Dai Quoc Nguyen, Raceview (AU); Cong Duy Vu Hoang, Wantirna South (AU); Duy Vu, Melbourne (AU); Gioacchino Tangari, Sydney (AU); Steve Wai-Chun Siu, Melbourne (AU); Dalu Guo, Sydney (AU); Budhaditya Saha, Sydney (AU); Thanh Tien Vu, Herston (AU); Yakupitiyage Don Thanuja Samodhye Dharmasiri, Melbourne (AU); Thanh Long Duong, Melbourne (AU); Anshuk Pal Chaudhuri, Bengaluru (IN); Prabhakara Reddy Munnangi, Hyderabad (IN); Subash Kumar Bhamidipati, Issaquah, WA (US)

(73) Assignee: Oracle International Corporation, Redwood Shores, CA (US)

(21) Appl. No.: 19/035,561

(22) Filed: Jan. 23, 2025

Related U.S. Application Data
(60) Provisional application No. 63/694,640, filed on Sep. 13, 2024.

(51) Int. Cl. G06N 3/096; G06F 16/242; G06N 3/0475

(52) U.S. Cl. CPC G06N 3/096; G06F 16/243; G06N 3/0475

(57) ABSTRACT

The present disclosure relates to manufacturing training and testing data by leveraging data augmentation techniques to generate examples of long context database schemas. Aspects are directed towards accessing a training dataset comprising training examples where each training example may include i) a prompt including a natural language utterance and a database schema having one or more tables, and ii) a gold logical form corresponding to the natural language utterance, combining the tables from the database schemas in the training examples may generate a combined database schema set, generating a set of long context training examples based on the training dataset and the combined database schema set, and incorporating the long context database schema into the selected training example to generate a long context training example to train a generative artificial intelligence model with at least the set of long context training examples to generate a trained generative artificial intelligence model.

### CROSS-REFERENCE TO RELATED APPLICATIONS

The present application is a non-provisional application of and claims the benefit and priority under 35 U.S.C. 119(c) of U.S. Provisional Application No. 63/694,640, filed Sep. 13, 2024, the entire contents of which is incorporated herein by reference for all purposes.

### FIELD

The present disclosure relates generally to converting natural language to a logical form, and more particularly, to data augmentation techniques for creating long-context benchmarking and fine-tuning datasets for the task of converting natural language to SQL, enabling the evaluation and improvement of large language models' (LLMs) effective context lengths in SQL generation.

### BACKGROUND

The advent of database management systems has revolutionized the way large datasets are stored, managed, and queried. Traditional databases, such as relational databases, have become the backbone of many applications across various industries. These databases are structured to store data in tables, allowing for the organization and retrieval of information in a systematic manner. The efficiency and reliability of databases have made them indispensable in fields such as finance, healthcare, and e-commerce, where large volumes of data need to be managed with precision and speed.

Structured Query Language (SQL) has been the primary tool for interacting with relational databases. SQL allows users to perform a wide range of operations, including data insertion, updates, deletions, and complex queries to retrieve specific information. The power and flexibility of SQL have made it the standard language for database management. However, the effective use of SQL requires a certain level of expertise, as constructing accurate and efficient queries can be complex and challenging for users who are not well-versed in the language.

In recent years, there has been a significant development in the field of databases with the emergence of text-to-SQL systems. These systems are designed to bridge the gap between natural language and SQL, enabling users to interact with databases using plain, conversational language. Text-to-SQL systems leverage advanced natural language processing (NLP) techniques and machine learning algorithms to translate user queries expressed in natural language into SQL commands. This innovation has the potential to democratize access to databases, allowing users without specialized SQL knowledge to efficiently retrieve and manipulate data.

The integration of text-to-SQL systems into database management represents a significant advancement in making databases more accessible and user-friendly. By simplifying the interaction with databases, these systems can enhance productivity and reduce the learning curve associated with database management. As businesses and organizations continue to accumulate and rely on large datasets, the ability to easily and accurately query databases using natural language will become increasingly valuable. This disclosure presents techniques related to the implementation and improvement of text-to-query language technologies including SQL, ensuring that the benefits of these advancements can be realized across various domains.

### BRIEF SUMMARY

Machine learning techniques are described herein (e.g., a method, a system, non-transitory computer-readable medium storing code or instructions executable by one or more processors) for creating long-context benchmarking and fine-tuning datasets for the task of converting natural language to SQL, enabling the evaluation and improvement of large language models' (LLMs) effective context lengths in SQL generation.

In various embodiments, a computer-implemented method is provided for that includes accessing a training dataset comprising training examples such that each training example may include i) a prompt including a natural language utterance and a database schema having one or more tables, and (ii) a gold logical form corresponding to the natural language utterance, combining the tables from the database schemas in the training examples to generate a combined database schema set, generating a set of long context training examples based on the training dataset and the combined database schema set, wherein generating the set of long context training examples comprises performing an iterative process for each training example that is selected from the training dataset. In some examples, the iterative process may include extending the database schema of the selected training example by: sampling one or more tables from the combined database schema set, and combining the sampled one or more tables with the one or more tables in the database schema to generate a long context database schema, and incorporating the long context database schema into the selected training example to generate a long context training example, such that each long context training example generated by the iterative process may include (i) a prompt including a natural language utterance and a long context database schema having a plurality of tables, and (ii) a gold logical form corresponding to the natural language utterance; and training a generative artificial intelligence model with at least the set of long context training examples to generate a trained generative artificial intelligence model.

In various embodiments, the database schema of the selected training example may be extended by the sampling and the combining until a combined context length of the prompt and the gold logical form is substantially close to but not exceeding a predefined context length.

In various embodiments, the predefined context length is fixed for each training example selected from the training dataset.

In various embodiments, the predefined context length is randomly sampled from a list of context length values for each training example selected from the training dataset.

In various embodiments, the sampled one or more tables are combined with the one or more tables in the database schema to generate a list of tables, and the tables in the list of tables are randomly shuffled to generate the long context database schema.

In various embodiments, the computer-implemented method further includes receiving an input from a user, the input comprising a natural language component, converting the input into a prompt, wherein the prompt comprises an instruction, a database schema associated with the natural language component, and an utterance associated with the natural language component, transmitting the prompt to the trained generative artificial intelligence model, receiving, from the trained generative artificial intelligence model, a logical form corresponding to the natural language utterance based at least in part on the prompt, executing the logical form on a database to obtain a query result, and providing the query result to the user.

In various embodiments, the iterative process may include selecting the training example from the training dataset, and the generative artificial intelligence model may be trained with the set of long context training examples and the training examples from the training dataset.

In some embodiments, a system is provided that includes one or more processors and one or more computer-readable media storing instructions which, when executed by the one or more processors, cause the system to perform part or all of the operations and/or methods disclosed herein.

In some embodiments, one or more non-transitory computer-readable media are provided for storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for an example NL2SQL tool, according to various embodiments.

FIG. 2 depicts a simplified diagram for an example generative AI SQL agent, according to various embodiments.

FIG. 3 depicts a simplified diagram for an example generative AI SQL agent, according to various embodiments.

FIG. 4 depicts a simplified block diagram for training, testing, and producing an NL2SQL Model, according to various embodiments.

FIG. 5 depicts a simplified block diagram for long context data augmentation for NL2SQL LLM fine-tuning and evaluating, according to various embodiments.

FIG. 6 depicts bar charts illustrating execution match accuracy for the NL2SQL model, according to various embodiments.

FIG. 7 depicts a line chart illustrating correctly predicted cases for the NL2SQL model, according to various embodiments.

FIG. 9 is a block diagram illustrating one pattern for implementing a cloud infrastructure as a service system, according to various embodiments.

FIG. 10 is a block diagram illustrating another pattern for implementing a cloud infrastructure as a service system, according to various embodiments.

FIG. 11 is a block diagram illustrating another pattern for implementing a cloud infrastructure as a service system, according to various embodiments.

FIG. 12 is a block diagram illustrating another pattern for implementing a cloud infrastructure as a service system, according to various embodiments.

FIG. 13 is a block diagram illustrating an example computer system, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

In recent years, the amount of data powering different industries and their systems has been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of its business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, and examples of programming query languages include, but are not limited to, SQL, PQL, GraphQL, SPARQL, and the like. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL could also enable digital assistants such as chatbots and others to improve their responses when the answer can be found in different databases or tables with different schemas.

In some instances, NL2SQL transforms natural language to SQL using generative artificial intelligence models such as large language models (LLMs). An LLM is a type of artificial intelligence (AI) that is trained to understand, generate, and manipulate human language (e.g., text data) in a coherent and contextually relevant manner. LLMs have resulted in significant progress in natural language processing tasks such as text-to-code (e.g., text-to-SQL), text generation and translation, and sentiment analysis. Duc to their attention mechanisms and deep neural architectures, LLMs excel at capturing nuanced language patterns and correlations in massive volumes of text data. LLMs are designed to predict the next word or token in a sequence of text by computing a probability distribution over a fixed vocabulary for the next token based on the context of the preceding tokens. The prediction is achieved through a series of self-attention mechanisms incorporated in the LLMs that assign varying degrees of importance to different parts of the input sequence that enable the LLMs to make informed predictions. LLMs generate contextually appropriate and coherent text by learning a fixed vocabulary from enormous text corpora and predicting which token included in the fixed vocabulary should be the next token in an output sequence.

To overcome these challenges and others, machine learning techniques disclosed herein implement a data augmentation method for creating long-context benchmarking and fine-tuning datasets for the NL2SQL task, enabling the evaluation and improvement of LLMs effective context lengths in SQL generation. By fine tuning a LLM on long contexts and shuffled table data for NL2SQL, the LLM is forced to identify the correct tables and columns within a large database schema, thereby enhancing its effective context length, robustness, and generalization. Some existing LLMs such as CodeQwen1.5-7B-Chat, Qwen2-7B-Instruct, Phi3-medium-128k-instruct claim that they can support long contexts; however, the performance of these existing LLMs degrades significantly when the context lengths increase. The experimental results discussed herein demonstrate that an LLM fine-tuned with long contexts significantly outperforms these conventional LLMs fine-tuned with original contexts on both original and long-context test sets.

In an exemplary embodiment, a method of fine-tuning is provided that comprises: accessing a training dataset comprising training examples, wherein each training example comprises: (i) a prompt including a natural language utterance and a database schema having one or more tables, and (ii) a gold logical form corresponding to the natural language utterance; combining the tables from the database schemas in the training examples to generate a combined database schema set; generating a set of long context training examples based on the training dataset and the combined database schema set, wherein generating the set of long context training examples comprises performing an iterative process for each training example that is selected from the training dataset, and wherein the iterative process comprises: extending the database schema of the selected training example by: sampling one or more tables from the combined database schema set, and combining the sampled one or more tables with the one or more tables in the database schema to generate a long context database schema; and incorporating the long context database schema into the selected training example to generate a long context training example, wherein each long context training example generated by the iterative process comprises: (i) a prompt including a natural language utterance and a long context database schema having a plurality of tables, and (ii) a gold logical form corresponding to the natural language utterance; and training a generative artificial intelligence model with at least the set of long context training examples to generate a trained generative artificial intelligence model.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc. Moreover, the term terms “about,” “similarly,” “substantially,” and “approximately” are used to provide flexibility to a numerical range endpoint by providing that a given value may be slightly above or slightly below the endpoint without affecting the desired result.

As used herein, when an action is “based on” something, this means the action can be based at least in part on at least a part of the something.

### Overview of Agents and NL2SQL Framework

An agent (also referred to as a skill, chatbot, chatterbot, talkbot, digital assistant, or the like) is a computer program that can perform conversations with end users. The agent can generally respond to natural-language messages (e.g., questions or comments) through a messaging application that uses natural-language messages. Enterprises may use one or more agent systems to communicate with end users through a messaging application. The messaging application, which may be referred to as a channel, may be an end user preferred messaging application that the end user has already installed and familiar with. Thus, the end user does not need to download and install new applications in order to chat with the agent system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

End users may interact with the agent system through a conversational interaction (sometimes referred to as a conversational user interface (UI)), just as interactions between people. In some cases, the interaction may include the end user providing a utterance such as query: “Please retrieve all invoices greater than ten thousand dollars for the last four years for Customer Y”, to the agent, and the agent responding with a natural language response for the query based on translation of the user's natural language query to a SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or other method of conveying a message. In some embodiments, the agent system may convert the content into a standardized logical form (e.g., a SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

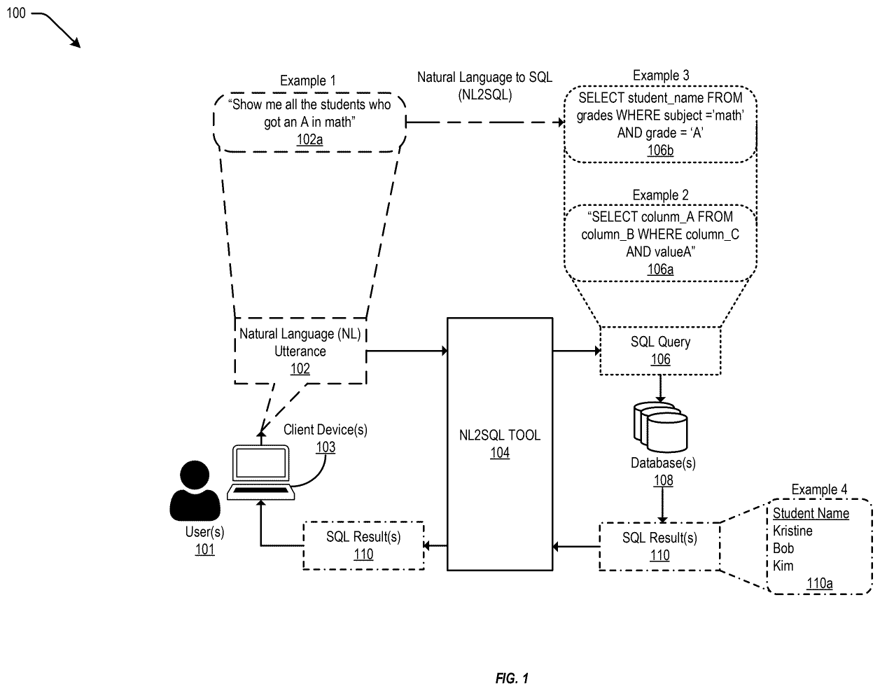

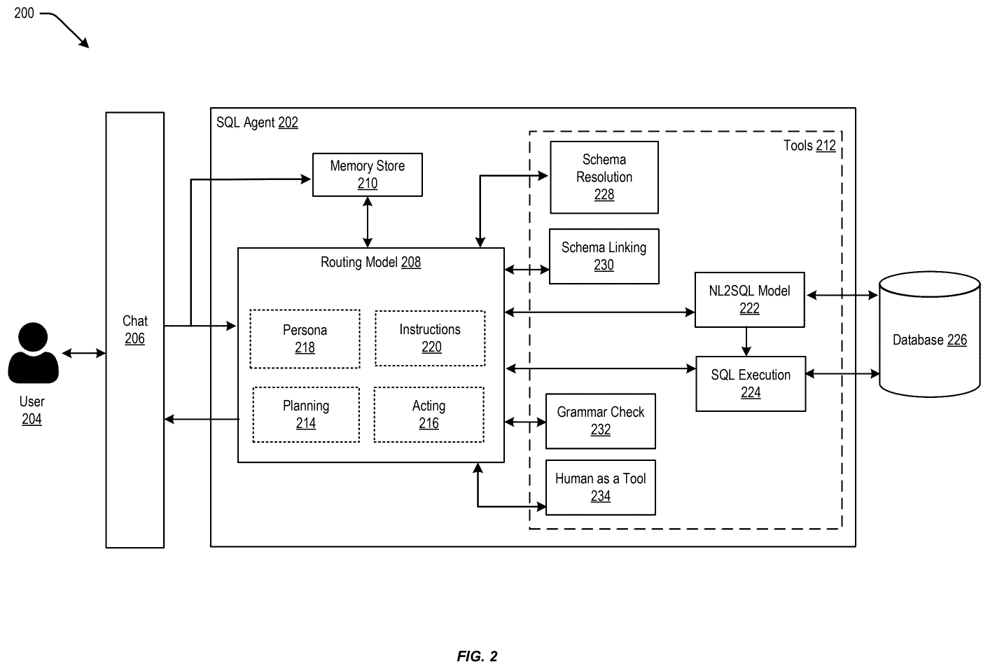

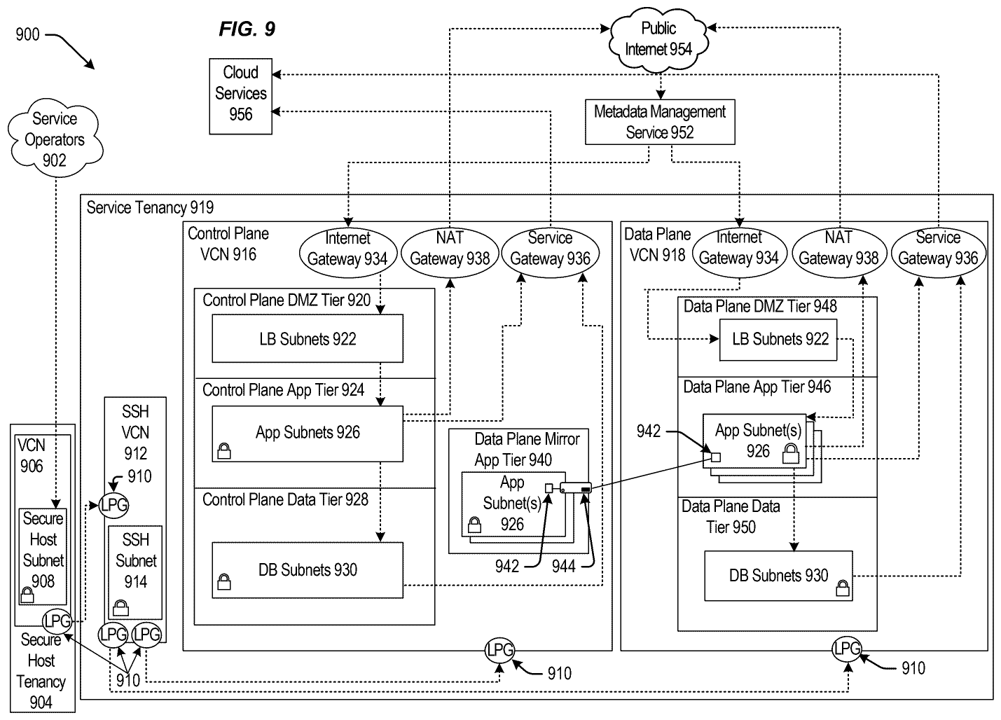

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for query). As shown in FIG. 1, the NL2SQL tool 104 is configured to generate a SQL query 106 and one or more SQL query result(s) 110 based on the provided natural language utterance 102, however other examples may implement tasks in addition to or alternative to SQL query generation (e.g., schema checking, schema linking, sentence completion, extraction of key information, debugging, and other SQL related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 9-13) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensure high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other NL2LF tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be or can include a natural language utterance 102. The natural language utterance can be in text form, such as when the user types a sentence, a question, a text fragment, or phrase and provides it as an input to the NL2SQL tool 104 via client device(s) 103. The client devices(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone or via a plug-in, or make use of some other audio-to-text translator, configured to translate the audio into text for further processing.

The NL2SQL tool 104 may be or may make use of one or more generative artificial intelligence models such as LLMs configured to generate a SQL query 106 (e.g., 106a or 106b) based on the natural language utterance 102. The NL2SQL tool 104 may receive a prompt including the natural language utterance 102 to generate a SQL query 106 that it is relevant to the user 101 preferences. In some implementations, the user 101 and/or client device 103 generate a prompt including the natural language utterance 102 before providing the prompt to the NL2SQL tool 104. In other implementations, the NL2SQL tool 104 receives the natural language utterance 102 and generates the prompt itself, e.g., populates slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain a SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally or alternatively, the NL2SQL tool 104 may provide the SQL query 106 to the user(s) via some other means such as an email communication, SMS message, or other type of notification receivable on one or more other computing devices. In some implementations, the SQL query 106 is provided to the user(s) in addition to or without running the SQL query 106 on the database(s) 108 to obtain SQL result(s) 110 (e.g., as part of a feedback request to validate the SQL query 106).

FIG. 2 is a simplified block diagram of a SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g.: sentence completion, summarization, extraction of key information from text passages), generative artificial intelligence can generate SQL statements. The purpose of the SQL agent system 200 is to enable users to talk to their databases with the least amount of effort. This may include the SQL agent system 200 interpreting user requests in natural language, reviewing database schema, implementing schema linking (i.e. identify names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include a SQL agent 202 capable of converting a natural language question into a SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide a user input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (i.e., trained task). Planning 214 includes generating a plan that is comprised of a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates a SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve accuracy of generated responses and customize responses generated by an LLM to the needs of the user 204. In some examples, planning 214 may select a tool from the tools 212 based on the persona 218.

TABLE 1

| Example Persona | Example Description |
|---|---|
| Junior Developer | A user having limited to no experience in writing |
| | SQL queries that requires assistance in writing and |
| | optimizing SQL queries. |
| Expert Developer | A user with several years of experience writing SQL |
| | queries. |
| Business Analyst | A user with strong context about the needs of a |
| | company and wants quick data insights without deep |
| | SQL knowledge. |
| Data Scientist | A user focused on extracting and analyzing data |
| | efficiently. |

Instructions 220 describe the knowledge bases and tools available to the SQL agent 202. Instructions 220 can be included in a prompt for LLM-based tools and may guide a tool to generate a response relevant to preferences of user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates a SQL query based on the prompt. The NL2SQL model 222 can be trained to convert a natural language question into a SQL query to help the user 204 complete data related tasks. In some examples, the SQL query generated by the NL2SQL model 222 is returned to the user 204 via the chat 206. Additionally, or alternatively, the generated SQL query is provided to a SQL execution 224 tool that is configured to execute SQL queries on the database 226. SQL execution 224 may receive a SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within a SQL statement. The SQL agent 202 may use schema resolution 228 after a SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user such as a developer for information for correcting previous generations.

The SQL agent 202 may use a singular tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 201 via the chat 202 as received by the routing model 208 (i.e., without additional modifications to the output).

In some implementations, the routing model 208 responds to the user 204 which provided the original query as part of a two-way conversation (e.g., via chat 206). The natural language response may include a natural language component (e.g., answers to questions, information, etc.) and/or a logical form component (e.g., a SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 201 via the chat 206. In some implementations, the SQL agent 202 may provide a visualization of the generated output through a plot, table, graph, and the like, via the chat 206. As a particular example, the SQL agent 202 can use the schema linking 230 tool to identify names of table and columns in a natural language utterance (which is an example of NL utterance 102 with respect to FIG. 1) provided by the user 204 and then generate a SQL query using the NL2SQL model 222 based on the identified table and column names. The SQL query may be provided to the user 201 via the chat 202 as generated by the NL2SQL model 222. In some implementations, the routing model 208 may generate a natural language response containing the SQL query and provide the natural language response to the user 201 via the chat 202.

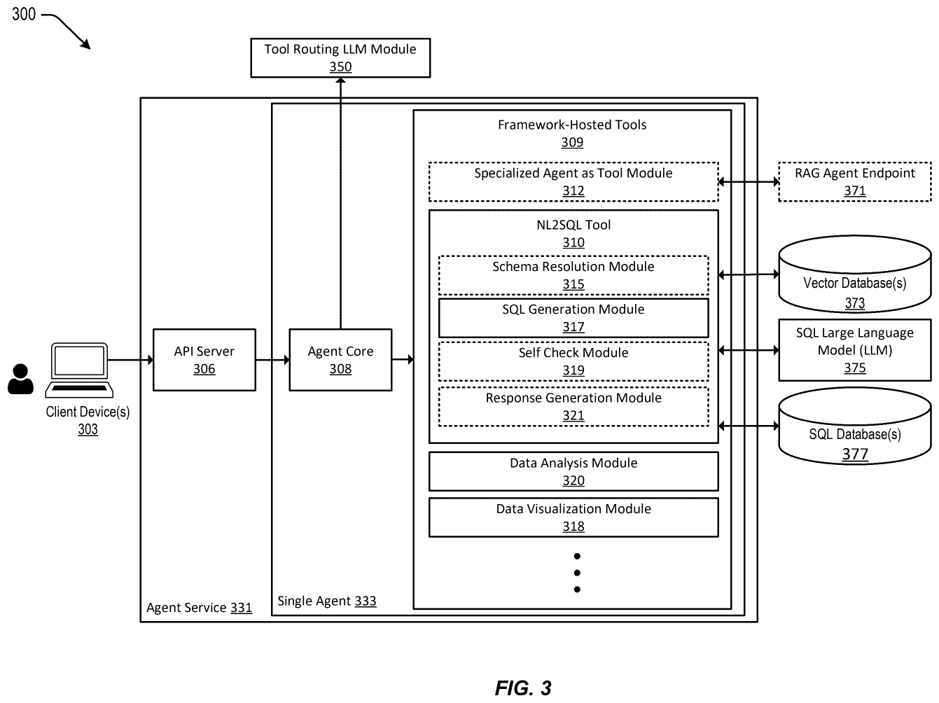

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to enable communication as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval augmented generation (RAG) endpoint 371. The RAG endpoint 371 may improve an efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the frame-work hosted tools 309 is a NL2SQL tool 310, which is an example of the NL2SQL model 218 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schema for any errors (e.g., syntax errors, sematic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is a SQL generation module 317. The SQL generation module 317 may take the utterance received from the client device(s) 303 and construct a SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with any one or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 includes data analysis module 320 and a data visualization module 318. Each of 320 and 318 may function with any of the modules of the framework-hosted tools 309 in order to analyze various analytics and display the various analytics. The analytics may include analysis of schema, SQL queries, LLM accuracy, recommendations, or suitable equivalents.

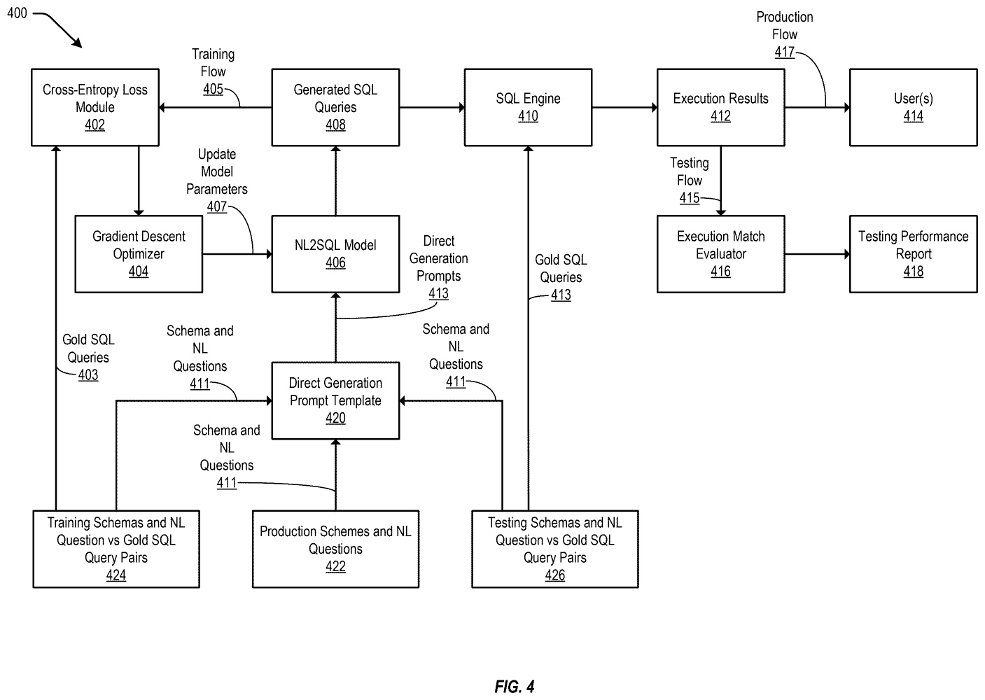

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language). A NL2SQL model is powered by a machine learning model (e.g., a LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the below description, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other system query languages such as PGQL and/or other intermediate logical forms such as MRL or OMRL.

The input to the Natural Language-to-SQL (NL2SQL) model is a natural language question.

### For Example:

“Get me the list of employees from Australia.”
The main output from the NL2SQL model is a SQL query.
For example:

```
  SELECT employee_id, employee_name FROM Employee WHERE country =
  “Australia”.
Another important input to the NL2SQL model 406 is the database schema that helps the
model to identify relevant tables and columns in the SQL output construction.
For example:
  CREATE TABLE Employee (
    employee_id TEXT(12) NOT NULL,
    employee_name TEXT(100) NOT NULL,
    birth_date DATE NOT NULL,
    hire_date DATE NOT NULL,
    country TEXT(100),
    ...
  )
  CREATE TABLE JobTitle (
    ...
  )
  ...
```

Described herein is a pre-trained NL2SQL model developed based on instruction fine-tuning of LLMs to provide this NL2SQL direct generation capability, e.g., the mapping of (Database Schema, NL Question)→SQL Query. Below is the summary of how the NL2SQL direct generation capability is implemented via instruction fine-tuning.

Data to train a NL2SQL model includes multiple database schemas defined as SQL CREATE TABLE statements:
Table names
Column names and types
Primary and foreign keys
Other constraints

### One Database Schema Example

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Each database schema can be associated with multiple pairs of natural language questions and corresponding SQL queries.

### Example of NL Question and Corresponding SQL Query

NL Question: “What is the name of the employee with salary greater than 100000 and with the most certificates to fly planes more than 5000?”
SQL Query: “SELECT T1.name FROM employee AS T1 JOIN certificate AS T2 ON
T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

Each question-query pair and its corresponding database schema are populated following a NL2SQL direct generation prompt template to create one direct generation prompt example:

### Direction NL2SQL Generation Prompt Example

Given an input Question, create a syntactically correct Oracle SQL query to run.
Pay attention to using only the column names that you can see in the schema description.
Be careful to not query for columns that do not exist. Also, pay attention to which column is in which table.
Please double check the SQL query you generate.
DO NOT use alias in the SELECT clauses.
Only use the tables listed below.

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Question: What is the name of the employee with salary greater than 100000 and with the most certificates to fly planes more than 5000?
SQL: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

The prompt example can then be sent to the LLM model to generate the SQL query during training and testing phases. The gold (ground truth) SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1” is used to evaluate the generated SQL query using a loss function such as cross-entropy loss (e.g., using cross-entropy loss module 402) in training and a performance metric such as execution match in testing. For execution match, both gold and generated SQL queries are executed on the database using the SQL engine. Their result sets are compared to check if they are matched.

The training and testing flows start at either a training schemas and NL question versus (vs) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space. Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts 413 from which the NL2SQL model 406 generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing. The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries are utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models such as the NL2SQL model where the model learns to generate SQL queries (output at block 408) based on the data training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using a SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model-its ability to perform well across different data samples and environments-highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 9-13).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into a SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step requires knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:

```
  “sql
  SELECT * FROM customers WHERE signup_date >= DATE_SUB(CURDATE( ),
INTERVAL 1 MONTH);
“
```

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using a SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the required data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected over time. This involves tracking the model's inference accuracy, response times, and other operational metrics. Additionally, the model may require retraining or updates based on new data or changing conditions in the environment it is applied in. This can be useful because machine learning models can drift over time due to changes in the underlying data they are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

As discussed above, various embodiments are directed to fine-tuning a current or pretrained NL2SQL model (e.g., a NL2SQL model trained as described with respect to FIGS. 2, 3, and 4) for an error correction capability for SQL queries incorrectly generated by the direct generation capability based on additional feedback from the SQL execution engine or the users. The error correction capability can be considered as a mapping of: (Database Schema, NL Question, Previous SQL Query, Error Message)→Revised SQL Query. In the below description, the LLM (Text-to-SQL model) is designed and trained to convert natural language queries into SQL queries with error correction capabilities. This involves understanding the semantics of the natural language input, mapping it to the corresponding database schema, understanding the error correction message and/or instructions, and generating a syntactically and semantically correct SQL query that can retrieve the desired information from the database without error. However, it should be understood that similar techniques could be implemented for other system query languages such as PGQL and/or other intermediate logical forms such as MRL or OMRL.

In order the implement the error correction capability, an instruction prompt fine-tuning approach is utilized to enhance a pretrained NL2SQL model. Firstly, an execution-based algorithm is used to collect execution and semantic error examples for fine-tuning the NL2SQL instruction to the LLM. The algorithm utilizes the existing direct NL2SQL model to generate LF queries from natural language input utterances. The generated and gold (ground truth) LF queries are then executed on a LF execution engine to extract execution and semantic errors which then are used to create error correction prompt examples based on a template. Secondly, an LLM-based approach is utilized to generate natural language correction instructions for semantic error examples. This approach helps eliminate expensive labelling costs by humans. A combination of instruction-enhanced direct generation and execution-based criterion are used to filter out low-quality LLM instructions. Semantic error examples with extended correction instructions are added to the error correction dataset to fine-tune a new NL2SQL model that can respond to both binary and instructional semantic feedback. Finally, a negative semantic error data augmentation method may be utilized to make the NL2SQL model more robust to incorrect user feedback.

Below is an exemplary instruction prompt template to generate training examples for the error correction capability.
“NL2SQL Error Correction Prompt:
Given an input Question and the previously generated SQLite SQL query with its execution error message, create a new syntactically and semantically correct SQLite SQL query to run.
Pay attention to using only the column names that you can see in the schema description.
Be careful to not query for columns that do not exist. Also, pay attention to which column is in which table.
Please double check the SQLite SQL query you generate.
DO NOT use alias in the SELECT clauses.
Only use the tables listed below.

{DATABASE_SCHEMA}
Question: {NL_QUESTION}
SQLite SQL: {PREVIOUS_SQL_QUERY}
[Error Message]: {ERROR_MESSAGE}

### New SQLite SQL:”

For each data tuple (Database Schema, NL Question, Previous SQL Query, Error Message)→SQL Query, its corresponding elements are populated into the sections {DATABASE_SCHEMA}, {NL_QUESTION}, {PREVIOUS_SQL_QUERY}, and {ERROR_MESSAGE} of the above template to create one error correction training example. The algorithms to generate the tuples are described in detail in the below sections. The error correction training examples can then be combined with NL2SQL direct generation training examples. A current or pretrained NL2SQL model is then fine-tuned with this combined data set so that the updated model can have both direct generation and error correction capabilities. In some instances, fine-tuning can be performed from scratch with a pretrained NL2SQL model on this combined data set to acquire both capabilities at the same time rather than sequentially. No matter whether the model is fine-tuned from scratch or from a current or pretrained NL2SQL model, at each training step the training examples are sampled from both sources with different sampling weights to ensure both capabilities are acquired, and the previous direct generation capability is not forgotten. Since the size of error correction data set is typically smaller than the size of direct generation data set, a sampling ratio such as 1:1 may be used to balance both prompt data sources. Moreover, if additional NL2SQL capabilities such as schema linking and explanation generation are desired, corresponding training prompt data can be created, and the training examples can be randomly sampled across these data sets during the fine-tuning process.

The goal of the first error correction algorithm is to generate error correction data tuples (Database Schema, NL Question, Previous SQL Query, Error Message) based on SQL query execution. The algorithm uses: (i) a data set of (Database Schema, NL Question)→SQL Query examples which are originally used to acquire a current direct NL2SQL model (referred to hereafter as direct NL2SQL data set), (ii) the current direct NL2SQL model (e.g., a NL2SQL model trained as described with respect to FIG. 4), and (iii) an SQL execution engine that can execute a SQL query on its corresponding database.

To generate error correction data tuples from a direct NL2SQL data set, the first error correction algorithm starts by considering each example, which includes a database schema and a natural language utterance (Database Schema, NL Question)→SQL Query. For each example, usM (e.g., M=10) random seeds to generate SQL queries. The SQL generation of the direct model is stochastic, e.g., for a different random seed parameter, it could produce the same or some different SQLs. To have a large data size for error correction examples, errors are simulated from the direct SQL generation. Hence, in this example ten different values for the random seed are used to get some variations in the generated SQLs. There is a likelihood to get one or two error examples from these ten random variations. The correct ones are ignored, and the one or two error examples are processed. Consequently, for each random seed, the current direct NL2SQL model generates one or more SQL queries based on the database schema and natural language utterance, e.g., (Database Schema, NL Question)→Generated SQL Query. Each generated SQL query is then executed on the database using the SQL engine. If the execution fails, the error message is recorded from the SQL engine and an execution error correction tuple is created, which includes the database schema, NL question, generated SQL query, and the error message (Database Schema, NL Question, Generated SQL Query, Error Message)→SQL Query. In order to determine a failure, the execution engine monitors, throughout the execution process, for any anomalies, interruptions, or errors. This includes keeping track of system responses, timeouts, and resource usage. If the execution encounters any issues such as syntax errors, runtime exceptions, missing resources, or system crashes, the engine detects these errors. An error message or code is typically generated by the system or database, which the execution engine captures.

If the command or query completes without errors and produces the expected result (e.g., correct data set, confirmation message), the execution is considered successful. Determination of an expected result may be determined by the SQL engine verifying the output against expected results or checking for an absence of error messages. If the execution succeeds, the SQL engine then executes the gold SQL query on the database. The result sets of both the generated SQL query and the gold SQL query are then compared. If the result sets are similar or the same, the first error correction algorithm moves on to the next step (e.g., if execution is ok and results matched, these examples are ignored. Only error cases are kept for use in constructing error correction examples). If they are not similar or the same, an error message is set as a statement of error, e.g., Set Error Message=“The SQL statement was executed against the database but the returned result set is not correct,” and a semantic error correction tuple is created, which includes the database schema, NL question, generated SQL query, and the error message/statement (Database Schema, NL Question, Generated SQL Query, Error Message)→SQL Query.

To increase the diversity and size of the error correction examples, different checkpoints of the current direct NL2SQL model can be used in addition to or alternative to the random seeds. All execution and semantic error correction tuples are collected into a data set. Both types of error correction tuples generally have the same format. Finally, these tuples are populated by the first error correction algorithm into the NL2SQL Error Correction Prompt to create error correction training examples. The error correction training examples are then used to finetune the current direct NL2SQL model using similar techniques to those described with respect to FIG. 4 and above. In some instances, the error correction training examples are used to augment the NL2SQL direct generation training examples (described with respect to FIG. 4) and are then used in combination to finetune the current direct NL2SQL model using similar techniques to those described above.

One important observation with the first error correction algorithm is that all semantic error examples share the same error message, e.g., “The SQL statement was executed against the database, but the returned result set is not correct.” This makes sense if users can only provide binary feedback such as thumb up or thumb down on the answer from the NL2SQL service. However, since users may be allowed through a Chat UI (e.g., agent) to enter some instructions to correct the previous SQL generation, there is a desire to extend the shared semantic error message with instructions specific for each error case. Consequently, for each semantic error example with the shared error message, one additional semantic error example may be created by a second error correction algorithm that creates natural language instructions to convert the error SQL query to the gold SQL query and these case-specific instructions are then appended to the shared semantic error message. Below is one example:
Question: Which States in Europe have at least 3 vehicle manufacturers?
Gold SQL Query: SELECT T1.CountryId, T1.CountryName FROM countries T1 JOIN continents T2 ON T1.Continent=T2.ContId JOIN car_makers T3 ON T1.CountryId=T3.Country WHERE T2.Continent=‘europe’ GROUP BY T1.CountryId, T1.Country Name HAVING COUNT (T3.Country)>=3.
Semantic Error SQL Query: SELECT T1.CountryName, T1.CountryId FROM countries T1 JOIN continents T2 ON T1.Continent=T2.ContId JOIN car_makers T3 ON T1.CountryId=T3.Country WHERE T2.Continent=‘europe’ GROUP BY T1.CountryName, T1.CountryId HAVING COUNT (T3.Country)>=3.
The shared semantic error message that will be replaced: The SQL statement was executed against the database, but the returned result set is not correct.
A semantic error message with specific instructions: The SQL statement was executed against the database, but the returned result set is not correct.
   1. Change “T3.Country” in the COUNT function to just “T3” to count the number of car manufacturers in each country.
   2. Remove “T1.CountryId” from the SELECT clause as it is not necessary for the answer.

These augmented examples with extended error messages will be added to the error examples during collection of the execution and semantic error correction tuples into a data set by the first error correction algorithm, as described above (which may ultimately be used to finetune the current direct NL2SQL model using similar techniques to those described above). Fine-tuning on these augmented examples allow the new model to respond to both binary and instruction semantic feedback. However, it is expensive to manually review each semantic error example and create correction instructions. Therefore, a pre-trained LLM (a pre-trained LLM separate from the direct NL2SQL model) such as Mixtral-8×7B-Instruct-v0.1 or Cohere Command R Plus is prompted by the second error correction algorithm to generate these instructions automatically.

In particular, for each semantic error example collected above by the first error correction algorithm, its Database Schema, NL Question, SQL Query, and Generated SQL Query fields are populated by the second error correction algorithm to the below NL2SQL Error Correction Instruction Generation Prompt template. To generate correction instructions for SQL queries from a direct NL2SQL model, the second error correction algorithm begins by considering M (e.g., M=ten) random seeds. Different random values of the random seed are used to generate a number (e.g., ten) of different varied candidates of instructions. The second error correction algorithm may filter out the non-optimal instructions (e.g., yield invalid results), and thus only keep instructions that are helpful (e.g., yield valid results). For each random seed, the pre-trained LLM generates one or more correction instructions based on the populated prompt and the current seed. These generated instructions are then appended to the thought section of the NL2SQL Direct Generation Prompt template. Next, the current direct NL2SQL model is tasked with generating K (K=five) random SQL queries using the populated NL2SQL Direct Generation Prompt. Each of these K generated SQL queries is executed, and their results are compared with the results from the gold SQL execution. If the proportion of matches between the generated queries and the gold queries is greater than or equal to a predetermined threshold, e.g., T (T=0.8), the instructions generated in the prior step are retained. These instructions are deemed effective as they assist the current direct NL2SQL model in arriving at the correct solution. If the proportion of matches between the generated queries and the gold queries is less than to the predetermined threshold, the instructions generated in the prior step are ignored.

With this random sampling approach, from each semantic error example, multiple examples with extended instruction messages can be generated, which can be used to finetune the current direct NL2SQL model using similar techniques to those described above (the NL variation of instructions could make the model more robust to user feedback). Below is an example of the NL2SQL Direct Generation Prompt.

### Text-to-SQL Error Correction Instruction Generation Prompt:

First you are given a database schema, a question, and the correct SQLite SQL query. You are then given a wrong SQLite SQL query for the question. You need to give a list of instructions to transform the wrong SQLite SQL into the correct one.
Just give the instructions to correct the wrong SQLite SQL query, don't include the correct SQLite SQL query.
Keep the instructions concise.
Don't include the corrected SQL.

Only use the tables listed below.

{DATABASE_SCHEMA}
Question: {NL_QUESTION}
Correct SQLite SQL: {SQL_QUERY}
Wrong SQLite SQL: {GENERATED_SQL_QUERY}

### Correction Instructions:

Text-to-SQL Direction Generation Prompt
Given an input Question, create a syntactically correct SQLite SQL query to run.
Pay attention to using only the column names that you can see in the schema description.
Be careful to not query for columns that do not exist. Also, pay attention to which column is in which table.
Please double check the SQLite SQL query you generate.
DO NOT use alias in the SELECT clauses.
Only use the tables listed below.

{DATABASE_SCHEMA}
Question: {NL_QUESTION}
Thought: {GENERATED_CORRECTION_INSTRUCTIONS}

### SQLite SQL:

Improving Large Language Models for NL2SQL with Long Context Finetuning

Large language models have become useful for many downstream applications in various industries (e.g., logistics, medical, chemical, etc.). One notable application is the automatic translation of NL utterances into SQL queries, enabling users to extract information from databases without requiring knowledge of SQL syntax. Due to LLM versatility in handling many distinct and disparate fields, conventional LLM-based NL2SQL models have been able to handle some NL2SQL tasks with mixed results (e.g., producing errors, incorrect SQL queries, etc.). The NL2SQL tasks typically aim to allow users to ask natural language questions to obtain the data from the given database. In general, the LLM-based models have attempted to leverage supervised instruction adjustments on the prompt data in various forms. In particular, conventional LLM-based models have attempted to leverage the LLM-based NL2SQL models to generate a SQL query for each input. However, due to the short length and the fixed order within the database schema in the existing NL2SQL data, it is a challenge for the LLM-based NL2SQL models to work with long contexts which are typical for large organizations. Some existing LLM models' performance degrades significantly when the context lengths increase.

To address these challenges and other, techniques are discussed herein for fine-tuning large language models on NL2SQL training data with long contexts and table shuffling. By adjusting a number of tables and shuffling those tables, the LLM model is forced attempt to locate and utilize the correct tables and columns. Consequently, the LLM model is fine-tuned to improve its effective context length, robustness, and generalization. Through a set of original and long context benchmarking data experiments it has been demonstrated that a LLM model fine-tuned with long contexts and/or table shuffling provides a significant technical improvement over conventionally trained LLM models that have been trained without long context and/or table shuffling.

To create augmented training data for supervised instruction fine-tuning and augmented test data for evaluation, tables from database schema sets in a training dataset are combined into a unified table set. Using a training example (from either the primary training set or other training sets), a prompt can be extended by randomly adding tables from this unified set, up to a specified length. For example, prompts may be extended to a predetermined maximum length, such as 32,000 tokens or, more specifically, 32,768 tokens. To ensure variation in prompt lengths, fine-grained bucket sizes can be used. These buckets, set at predetermined intervals (e.g., 500 tokens or, more specifically, 512 tokens), allow for prompts of varying lengths within a range (e.g., from 5,120 tokens to 32,768 tokens).

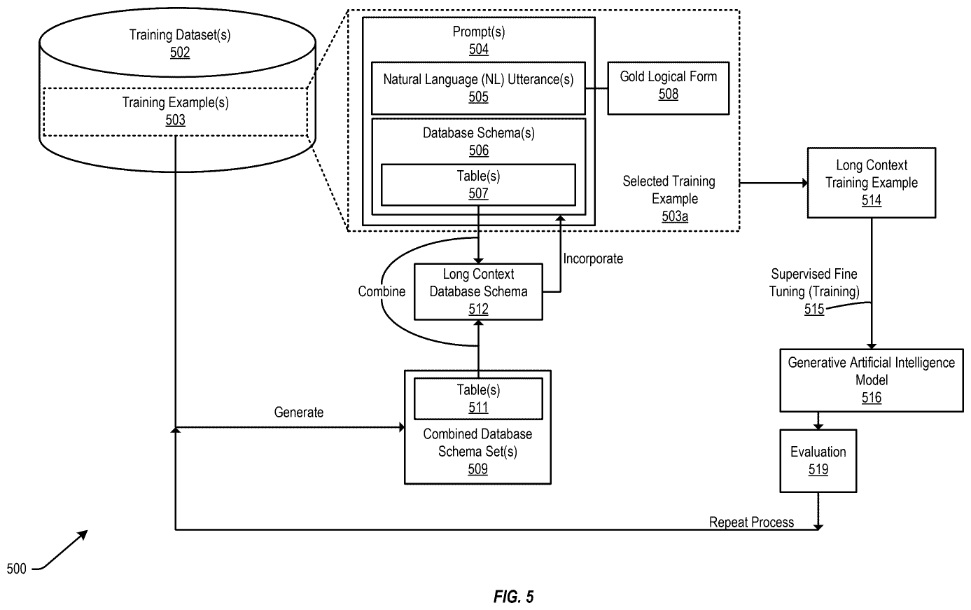

FIG. 5 depicts a simplified block diagram 500 for long context data augmentation for NL2SQL LLM fine-tuning and evaluation, according to various embodiments. By way of a non-limiting example, one or more training datasets(s) 502 include one or more training example(s) 503 which are used to train a large language model (LLM) to convert a natural language (NL) utterance (which is an example of NL utterance 102 with respect to FIG. 1) to a structured query language (SQL) query. The training example(s) 503 include, for example, prompt(s) 504, NL utterance(s) 505 (as discussed with respect to FIG. 1), database schema(s) 506, and a gold logical form 508 (e.g., ground truth SQL query) associated with each NL utterance(s) 505. The gold logical form 508 may include information that is known to be true (e.g., from previous verification) and/or obtained through historical data and/or input (e.g., user defined). The database schema(s) 506 include one or more table(s) 507 (as discussed with respect to FIG. 4) with information relating to various parameters. For example, the database schema(s) 506 may represent creating tables for invoices an airline paid in a quarter. As previously discussed, the database schemas describe the structure of a database, including the tables, the fields within those tables, the relationships between the tables, and any constraints or rules governing the data. Each table in the database represents a collection of related data. Columns represent the attributes or properties of the data stored in the table. Each column has a name and a data type (e.g., integer, varchar, date).

In order to provide supervised fine tuning 515 to one or more generative artificial intelligence model 516, one or more tables from a database of training dataset(s) 502 (e.g., Spider training examples) may be combined to generate a collection of combined database schema set(s) 509 which include a corresponding number of table(s) 511 associated with each schema, respectively. The table(s) 511 may be combined with the table(s) 507 from a selected training example 503a to form long context database schema 512. The long context database schema 512 may then be incorporated into the selected training example 503a, which combines the tables within respective schema. The tables may be combined at random, according to a pattern or sequence, or may be user/machine defined. In addition, or alternatively, the tables may be suitably shuffled (e.g., shifting positions of the tables in the data) before combining, concurrently with combining, after combining, or combinations thereof to provide sufficient randomness to table placement within the schema.

The tables can be added up to a predefined context length. In some examples, the predefined context length is defined at least in part by a combined context length of the prompt 504 and the gold logical form (e.g., less than or equal to 66,000 tokens). For each selected training example 503a, the predefined context length may be fixed or may suitably vary. By way of a non-limiting example, the predefined context length may be randomly sampled from a list of context length values (retrieved from a data store or user predefined) for each of the selected training examples 503a. In some examples, prompt lengths may be diversified using a bucket size of five hundred and twelve tokens for buckets from a first token length (e.g., 5,210) to a second bucket length (e.g., 32,768). Subsequently, a long context training example 514 may be generated based at least in part on combining the tables. This process may be repeated for each training example within the training examples 503 to generate a set of long context training examples (not depicted).

Each long context training example 514 may be input into the generative artificial intelligence model 516 individually or in groups. For example, each long context training example 514 may be input into the LLM where the generative artificial intelligence model 516 may undergo evaluation (as discussed in more detail further on). If the output of the generative artificial intelligence model 516 is not within an acceptable threshold, the long context training example 514 may have additional tables added to respective schema at random which undergo another shuffling operation. The long context training example 514 may then be re-input into the generative artificial intelligence model 516. The process may be repeated any suitable number of times based at least in part on an evaluation. In some examples, the evaluation is optional, and the process may complete once a threshold number of training examples from the training example(s) 503 (e.g., some or all training examples) have been used to train the generative artificial intelligence model 516.

The steps involved in the long context training example 514 can be described in a simplified example algorithm using a fine-grained bucket size of five hundred and twelve tokens for buckets from 5,120 to 32,7268. The algorithm can be performed for each training example in the training dataset(s) 502. For example:

```
Algorithm: Long Context Data Augmentation for NL2SQL Fine-tuning
  Input: The training examples S = {((instruction_sᵢ, database_schema_sᵢ, question_sᵢ),
  gold_sql_sᵢ)}^{N}_{i = 1}, wherein each database_schema_sᵢ is a set of tables {table_sᵢⱼ}ⱼ₌₁, the
  training examples E = {((instructionᵢ, database_schemaᵢ, questionᵢ), gold_sqlᵢ)}^{M}_{i = 1},
  wherein each database_schemaᵢ is a set of tables {tableᵢⱼ}ⱼ₌₁ , and the base model's
  tokenizer tk.
  Output: The extended training examples E′.
  additional_tables ← { }
  table_lengths ← { }
  num_tables ← 0
  table_names ← { }
  for ((instruction_s, database_schema_s, question_s), gold_sql_s) in S do
    for table_s in database_schema_s do
          if table_s not in additional_tables then
              additional_tables ← additional_tables U {table_s}
              table_lengths ← table_lengths U {get_length(table, tk)}
            num_tables ← num_tables + 1
            table_names ← table_names U get_table_name(table)
  E′ ← { }
  lengths ← range(5120, 32768, 512)
  for ((instruction, database_schema, question), gold_sql) in E do
    original_length ← get_length(instruction + database_schema + question + gold_sql,
  tk)
    new_length ← randomly_select_value(lengths)
    local_table_names ← { }
    for table in database_schema do
      local_table_names ←local_table_names U get_table_name(table)
    extended_tables ← { }
    for idx in shuffle(range(num_tables)) do
        if additional_tables[idx] not in database_schema and table_names[idx] not in
  local_table_names and original_length + table_lengths[idx] < new_length then
          original_length ← original_length + table_lengths[idx]
          extended_tables ← extended_tables U {additional_tables[idx]}
    shuffled_extended_schema ← shuffle(extended_tables U database_schema)
    E′ ← ((instruction, shuffled_extended_schema, question), gold_sql)
  E′ ← E′ U E
```

Where “i” is a number between zero and a total number of schema within the database(s) of schema(s), “j” is a number between zero and a total number table number of tables, S is a total number of training examples, idx is table i with a number of parameters in the table dx, E is selected training examples, and E′ is the long context training example (e.g., long context training example 514) which is E extended with the tables (e.g., tables 511), tk is a model tokenizer (e.g., a maximum characters allowed). The algorithm may be implemented in software (e.g., code, instructions, program) executed by one or more processing units (e.g., processors, cores) of the respective systems, hardware, or combinations thereof. The software may be stored on a non-transitory storage medium (e.g., on a memory device). The algorithm above is intended to be illustrative and non-limiting. Although the algorithm depicts the various processing steps occurring in a particular sequence or order, this is not intended to be limiting. In certain alternative embodiments, the steps may be performed in some different order, or some steps may also be performed in parallel. In certain embodiments, such as in the embodiments depicted in FIGS. 1-4, the algorithm may be performed by a pre-processing subsystem to generate long context training examples.

Evaluating an effectiveness of fine-tuning models may be determined (e.g., at evaluation 519) using augmented data including long context testing examples and shuffled tables. To do this, the lengths of the original prompts in test sets, which may be the same training sets (e.g., Spider training sets) or different training sets (e.g., Bird training sets), are extended using the same process discussed above to curate long-context fine-tuning of the generative artificial intelligence model 516 as described above. Some or all of the tables within the training set may be combined to create a combined table set. Then, given each test example, the added tables may be randomly selected from this combined set. By way of a non-limiting example, eight context lengths can be used: 8,192, 16,384, 24,576, 32,768, 40,960, 49,152, 57,344, and 65,536. The algorithm can be performed for each testing example in the training dataset(s) 502. For example, the following simplified example algorithm can be used:

```
Algorithm 2: Long Context Data Augmentation for NL2SQL Evaluation
Input: Bird training examples B = {((instruction_bᵢ, database_schema_bᵢ, question_bᵢ),
gold_sql_bᵢ)}^{N}_{i = 1}, wherein each database_schema_bᵢ is a set of tables {table_bᵢⱼ}ⱼ₌₁, the test
examples E = {((instructionᵢ, database_schemaᵢ, questionᵢ), gold_sqlᵢ)}^{M}_{i = 1}, wherein each
database_schemaᵢ is a set of tables {tableᵢⱼ}ⱼ₌₁, and the base model's tokenizer tk.
Output: New test examples E′.
additional_tables ← { }
table_lengths ← { }
num_tables ← 0
table_names ← { }
for ((instruction_b, database_schema_b, question_b), gold_sql_b) in B do
  for table_b in database_schema_b do
      if table_b not in additional_tables then
          additional_tables ← additional_tables U {table_b}
          table_lengths ← table_lengths U {get_length(table, tk)}
        num_tables ← num_tables + 1
        table_names ← table_names U get_table_name(table)
for length in range(8192, 65536, 8192) do
  E′ ← { }
  for ((instruction, database_schema, question), gold_sql) in E do
    original_length ← get_length(instruction + database_schema + question + gold_sql, tk)
    new_length ← randomly_select_value(lengths)
    local_table_names ← { }
    for table in database_schema do
      local_table_names ←local_table_names U get_table_name(table)
    extended_tables ← { }
    for idx in shuffle(range(num_tables)) do
          if additional_tables[idx] not in database_schema and table_names[idx] not in
local_table_names and original_length + table_lengths[idx] < new_length then
          original_length ← original_length + table_lengths[idx]
          extended_tables ← extended_tables U {additional_tables[idx]}
    shuffled_extended_schema ← shuffle(extended_tables U database_schema)
    E′ ← ((instruction, shuffled_extended_schema, question), gold_sql)
  save_data(E′)
```

The algorithm may be implemented in software (e.g., code, instructions, program) executed by one or more processing units (e.g., processors, cores) of the respective systems, hardware, or combinations thereof. The software may be stored on a non-transitory storage medium (e.g., on a memory device). The algorithm above is intended to be illustrative and non-limiting. Although the algorithm depicts the various processing steps occurring in a particular sequence or order, this is not intended to be limiting. In certain alternative embodiments, the steps may be performed in some different order, or some steps may also be performed in parallel. In certain embodiments, such as in the embodiments depicted in FIGS. 1-4, the algorithm may be performed by a pre-processing subsystem to generate long context training examples.

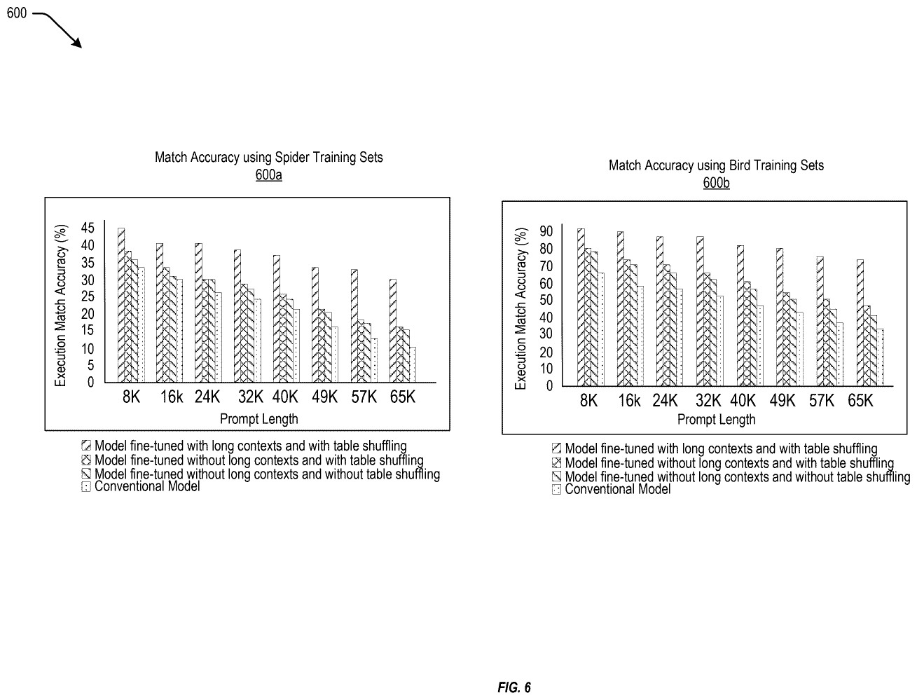

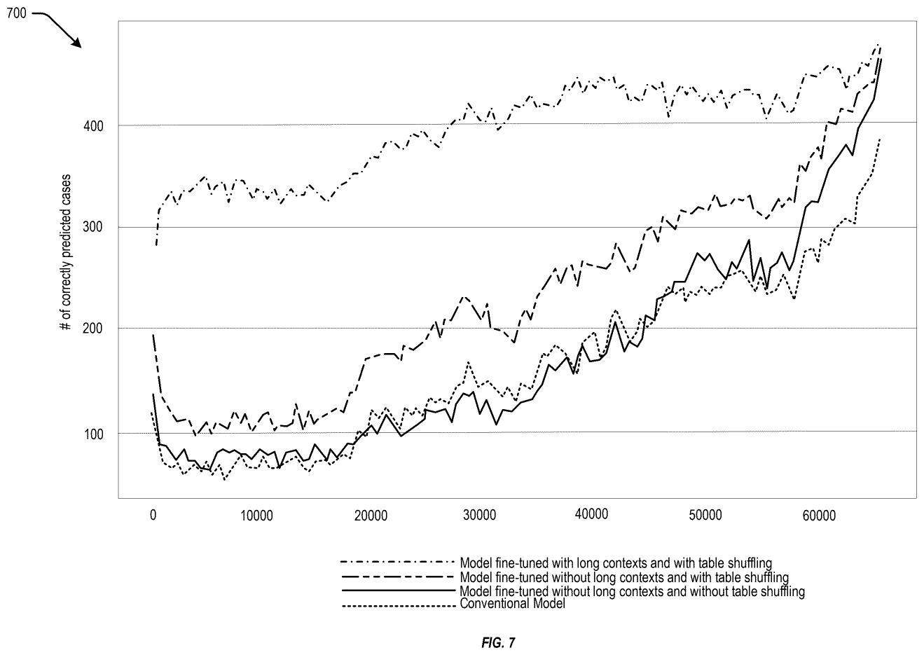

FIG. 6 depicts bar charts illustrating execution match accuracy for the NL2SQL model, according to various embodiments. As depicted, a conventional model was used to compute the numbers of tokens in the full prompts for training sets (e.g., Spider and Bird training sets), each including instructions, database schemas, NL questions, SQL queries. Their maximum numbers of tokens are 3,072 and 8,192 respectively and represent the values for the model's context length during the fine-tuning process for the training sets. In general, since conventional LLM-based NL2SQL models usually use 8,192 a fixed context length during fine-tuning, the conventional LLM-based NL2SQL models do not work well on long database schemas where context lengths are much higher than 8,192 tokens. This is because they are not fine-tuned on long database schemas or contexts. In addition, since the table order in the database schemas are fixed across training examples for the conventional model, the conventional model is less robust to the variation in positions of relevant tables within long contexts.

In contrast to the conventional model, the NL2SQL model of the present disclosure is fine-tuned on training data including long context examples, where data augmentation techniques are used to extend the prompts of existing datasets to generate long contexts with table shuffling and random tables from the training sets (e.g., Spider, Bird, etc.). As depicted, for tokens between 8,000 and 65,000, an execution match accuracy (e.g., chart 600a) between around forty five percent (for around 8,000) and thirty percent (for around 65,000) is demonstrated compared to the conventional model accuracy of between thirty four percent (for around 8,000) and eleven percent (for around 65,000). This represents an increase of fifteen percent on the low-end tokenization and an increase of nineteen percent on the high-end tokenization. Similar technical improvements of the present disclosure over conventional LLM training methods are depicted in chart 600b using the Bird training sets for evaluation of the LLM.

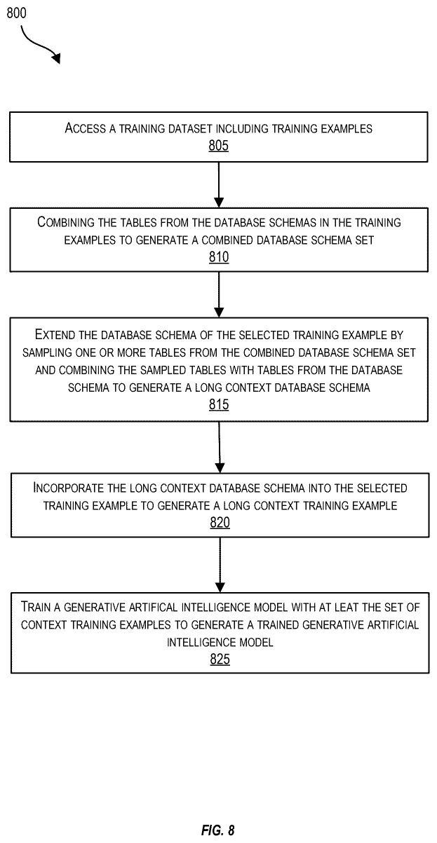

FIG. 7 depicts a line chart 700 illustrating correctly predicted cases for the NL2SQL model, according to various embodiments. One challenge in working with long schemas is that the order of relevant tables/columns across user questions may not be consistent. To further evaluate the robust impact of the long context fine-tuned model, relevant tables/columns were placed in different bucket positions to check whether the models can detect them. First, the Spider training sets were combined, and a subset of samples was extracted, where each sample had a maximum prompt length of five hundred and twelve tokens. Then, an algorithm (e.g., evaluation algorithm as discussed previously) was used to extend the prompt into the context length of 65k tokens. The original database schemas were placed into buckets ranging from five hundred and twelve to 65k tokens where the bucket size was five hundred and twelve tokens generating one hundred and twenty-eight bucket test sets. Finally, a number of correctly executed samples (over a total of six hundred and fifty-one samples) for each bucket test set was calculated. As depicted in chart 800, the long context fine-tuned NL2SQL model of the present disclosure provides significant robustness compared to the conventional models.

FIG. 8 is a flowchart illustrating a process 800 for training a large language model for natural language to SQL, according to various embodiments. The processing depicted in FIG. 8 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 8 and described below is intended to be illustrative and non-limiting. Although FIG. 8 depicts the various processing steps occurring in a particular sequence or order, this is not intended to be limiting. In certain alternative embodiments, the steps may be performed in some different order or some steps may also be performed in parallel. In certain embodiments, such as in the embodiments depicted in FIGS. 1-5, the processing depicted in FIG. 8 may be performed by a pre-processing subsystem to generate augmented data sets for training one or more models (e.g., a NL2SQL LLM).

At step 805, a training dataset including training examples may be accessed. Each training example of the training examples may include a prompt (e.g., a prompt with respect to FIG. 1) including a NL utterance (e.g., text, sentence, question, etc.) and a database schema having one or more tables. Each training example may include a gold logical form corresponding to the NL utterance and represent a ground truth SQL query associated with the NL utterance. In some embodiments, the prompt can include one or more questions, statements, or requests for information related to tables within the database schema. The training dataset may include any suitable number of training examples.

At step 810, the tables from the database schemas (e.g., tables 507 within database schema(S) 506 with respect to FIG. 5) may be combined to generate a combined (e.g., long context) database schema set (e.g., long context database schema 512 with respect to FIG. 5). The tables may be from one or more training sets (e.g., Bird, Spider, etc.) and may be combined at random. Some or all the tables within the training set may be combined to create a combined table set. Then, given each test example, the added tables may be randomly selected from this combined set.

At step 815, the database schema of the selected training example may be extended by sampling one or more tables from the combined database schema set and combining the sampled tables with tables from the database schema to generate a long context database schema. In addition, or alternatively, the tables may be shuffled (e.g., randomly) once combined into the combined database schema set. In some examples, generating the set of long context training examples includes performing an iterative process for each training example that is selected from the training dataset. In some embodiments, the iterative process includes selecting the training example from the training dataset, and the generative artificial intelligence model is trained with the set of long context training examples and the training examples from the training dataset.

In some embodiments, the database schema of the selected training example is extended by the sampling and the combining until a combined context length of the prompt and the gold logical form is substantially close to but not exceeding a predefined context length. The predefined context length may be fixed for each training example selected from the training dataset or may be randomly sampled from a list of context length values for each training example selected from the training dataset. In some examples, the database schema may be shuffled prior to adding to the selected training examples, and after the database schema are added, are shuffled again with the existing schema in the training examples.

At step 820, the long context database schema may be incorporated into the selected training example to generate a long context training example. The long context database schema may be added at random or according to a predefined structure (e.g., a historically accurate combined schema dataset). In some examples, a user (e.g., developer) can select how many long context database schemas may be added to selected training examples and/or may select which training examples may be candidates from a group of training examples to have long context database schema added.

At step 825, a generative artificial intelligence model (e.g., NL2SQL Model 406, an LLM, with respect to FIG. 4 for example) may be trained with at least the set of long context training examples to generate a trained generative artificial intelligence model. The trained generative artificial intelligence model may then be used to receive an input from one or more users (e.g., chat 202 with respect to FIG. 2). For example, an input may be part of a two-way conversation between an agent (e.g., agent 333 with respect to FIG. 3). The agent converts the input into a prompt, where the prompt includes at least the input (e.g., a user utterance such as audio, visual, etc.). The agent may then retrieve an instruction, one or more database schema associated with the input, and optionally, a gold logical form associated with a training example that may be similar to the input (e.g., a similar previous question) and provide the combined input to the trained generative artificial intelligence.

The trained generative artificial intelligence may then process the combined input in order to provide an output that includes at least a logical form corresponding to the user utterance (e.g., natural language utterance) based at least in part on the prompt. In some embodiments, the agent may first apply the logical form to a database (e.g., SQL database) in order to retrieve results associated with the logical form and then provide the results to the user. In other embodiments, the agent may provide the logical form back to the user in a raw form for the user to submit to a database.

### Illustrative Systems

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

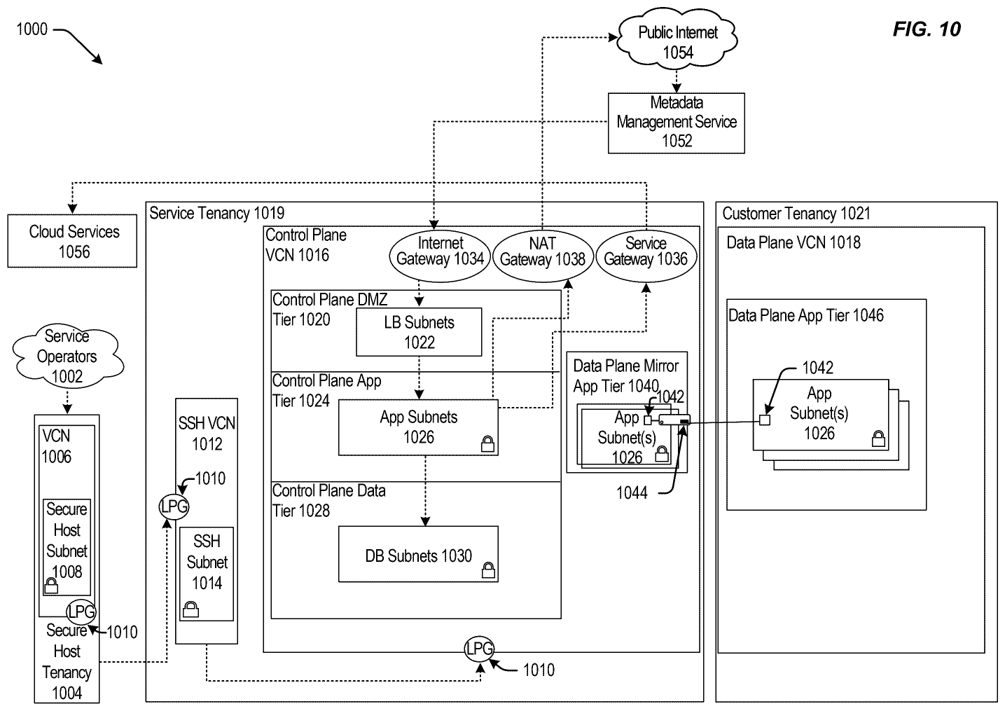

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

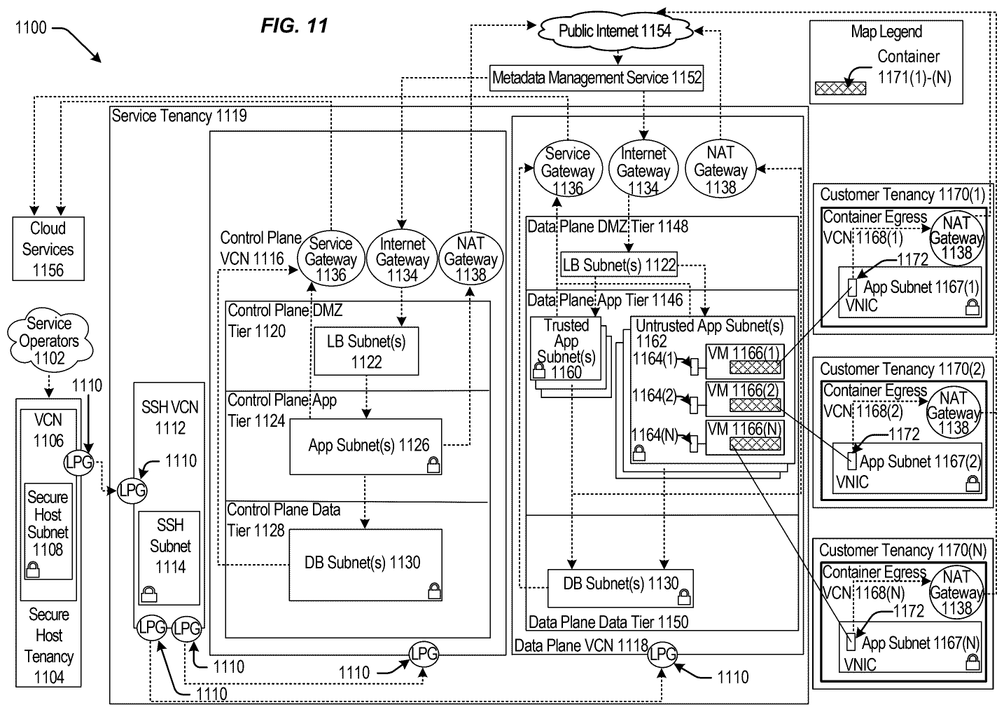

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

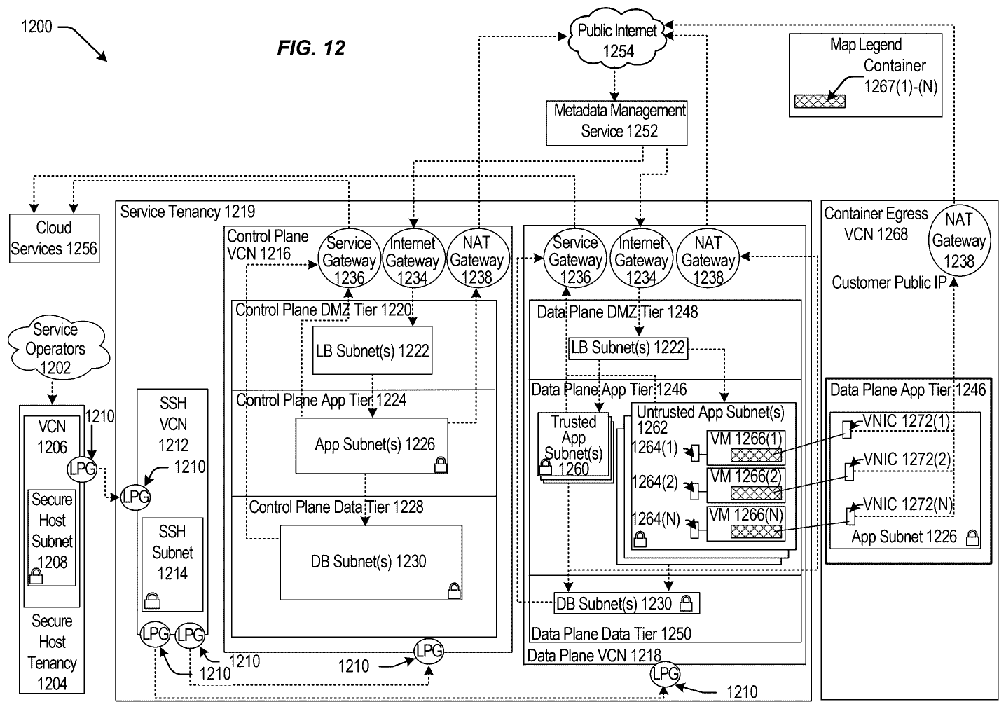

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1226 (e.g., the LPG 910 of FIG. 9) that can be communicatively coupled to an SSH VCN 1212 (e.g., the SSH VCN 912 of FIG. 9) via an LPG 1226 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1226 contained in the control plane VCN 1216 and to a data plane VCN 1218 (e.g., the data plane 918 of FIG. 9) via an LPG 1226 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

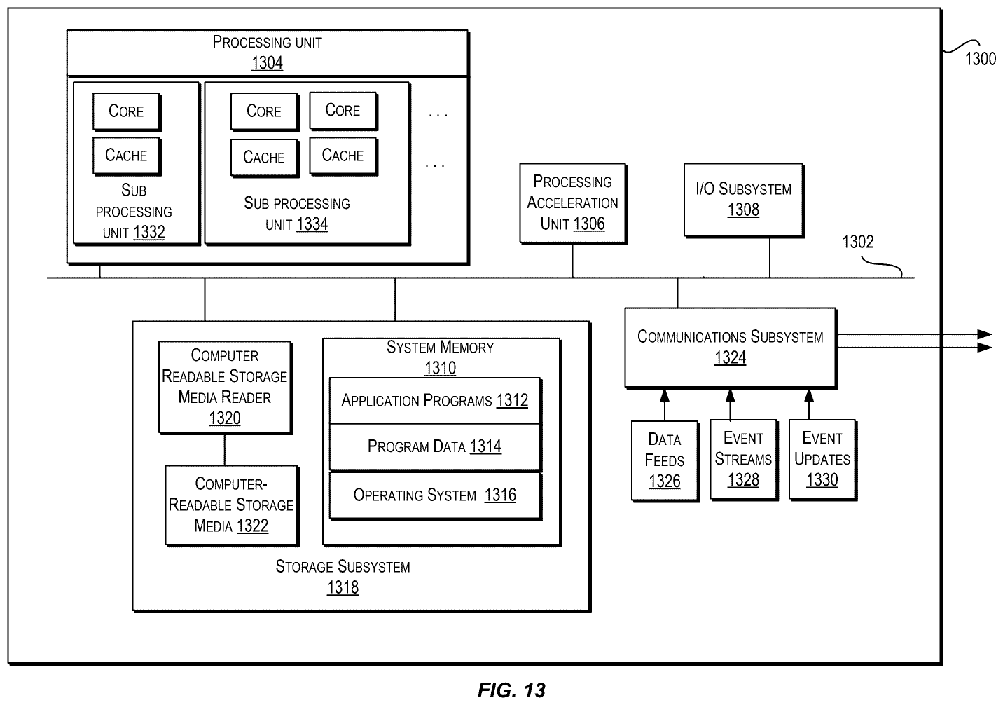

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed:

1. A computer-implemented method comprising:
accessing a training dataset comprising training examples, wherein each training example comprises: (i) a prompt including a natural language utterance and a database schema having one or more tables, and (ii) a gold logical form corresponding to the natural language utterance;
combining the tables from the database schemas in the training examples to generate a combined database schema set;
generating a set of long context training examples based on the training dataset and the combined database schema set, wherein generating the set of long context training examples comprises performing an iterative process for each training example that is selected from the training dataset, and wherein the iterative process comprises:
extending the database schema of the selected training example by: sampling one or more tables from the combined database schema set, and combining the sampled one or more tables with the one or more tables in the database schema to generate a long context database schema, and
incorporating the long context database schema into the selected training example to generate a long context training example,
wherein each long context training example generated by the iterative process comprises: (i) a prompt including a natural language utterance and a long context database schema having a plurality of tables, and (ii) a gold logical form corresponding to the natural language utterance; and
training a generative artificial intelligence model with at least the set of long context training examples to generate a trained generative artificial intelligence model.

2. The computer-implemented method of claim 1, wherein the database schema of the selected training example is extended by the sampling and the combining until a combined context length of the prompt and the gold logical form is substantially close to but not exceeding a predefined context length.

3. The computer-implemented method of claim 2, wherein the predefined context length is fixed for each training example selected from the training dataset.

4. The computer-implemented method of claim 2, wherein the predefined context length is randomly sampled from a list of context length values for each training example selected from the training dataset.

5. The computer-implemented method of claim 1, wherein the sampled one or more tables are combined with the one or more tables in the database schema to generate a list of tables, and the tables in the list of tables are randomly shuffled to generate the long context database schema.

6. The computer-implemented method of claim 1, further comprising:
receiving an input from a user, the input comprising a natural language component;
converting the input into a prompt, wherein the prompt comprises an instruction, a database schema associated with the natural language component, and an utterance associated with the natural language component;
transmitting the prompt to the trained generative artificial intelligence model;
receiving, from the trained generative artificial intelligence model, a logical form corresponding to the natural language utterance based at least in part on the prompt;
executing the logical form on a database to obtain a query result; and
providing the query result to the user.

7. The computer-implemented method of claim 1, wherein the iterative process further comprises selecting the training example from the training dataset, and wherein the generative artificial intelligence model is trained with the set of long context training examples and the training examples from the training dataset.

8. A system comprising:
one or more processors; and
one or more computer-readable media storing instructions which, when executed by the one or more processors, cause the system to perform operations comprising:
accessing a training dataset comprising training examples, wherein each training example comprises: (i) a prompt including a natural language utterance and a database schema having one or more tables, and (ii) a gold logical form corresponding to the natural language utterance;
combining the tables from the database schemas in the training examples to generate a combined database schema set;
generating a set of long context training examples based on the training dataset and the combined database schema set, wherein generating the set of long context training examples comprises performing an iterative process for each training example that is selected from the training dataset, and wherein the iterative process comprises:
extending the database schema of the selected training example by: sampling one or more tables from the combined database schema set, and combining the sampled one or more tables with the one or more tables in the database schema to generate a long context database schema, and
incorporating the long context database schema into the selected training example to generate a long context training example,
wherein each long context training example generated by the iterative process comprises: (i) a prompt including a natural language utterance and a long context database schema having a plurality of tables, and (ii) a gold logical form corresponding to the natural language utterance; and
training a generative artificial intelligence model with at least the set of long context training examples to generate a trained generative artificial intelligence model.

9. The system of claim 8, wherein the database schema of the selected training example is extended by the sampling and the combining until a combined context length of the prompt and the gold logical form is substantially close to but not exceeding a predefined context length.

10. The system of claim 9, wherein the predefined context length is fixed for each training example selected from the training dataset.

11. The system of claim 9, wherein the predefined context length is randomly sampled from a list of context length values for each training example selected from the training dataset.

12. The system of claim 8, wherein the sampled one or more tables are combined with the one or more tables in the database schema to generate a list of tables, and the tables in the list of tables are randomly shuffled to generate the long context database schema.

13. The system of claim 8, further comprising:
receiving an input from a user, the input comprising a natural language component;
converting the input into a prompt, wherein the prompt comprises an instruction, a database schema associated with the natural language component, and an utterance associated with the natural language component;
transmitting the prompt to the trained generative artificial intelligence model;
receiving, from the trained generative artificial intelligence model, a logical form corresponding to the natural language utterance based at least in part on the prompt;
executing the logical form on a database to obtain a query result; and
providing the query result to the user.

14. One or more non-transitory computer-readable media storing instructions which, when executed by one or more processors, cause the one or more processors to perform operations comprising:
accessing a training dataset comprising training examples, wherein each training example comprises: (i) a prompt including a natural language utterance and a database schema having one or more tables, and (ii) a gold logical form corresponding to the natural language utterance;
combining the tables from the database schemas in the training examples to generate a combined database schema set;
generating a set of long context training examples based on the training dataset and the combined database schema set, wherein generating the set of long context training examples comprises performing an iterative process for each training example that is selected from the training dataset, and wherein the iterative process comprises:
extending the database schema of the selected training example by: sampling one or more tables from the combined database schema set, and combining the sampled one or more tables with the one or more tables in the database schema to generate a long context database schema, and
incorporating the long context database schema into the selected training example to generate a long context training example,
wherein each long context training example generated by the iterative process comprises: (i) a prompt including a natural language utterance and a long context database schema having a plurality of tables, and (ii) a gold logical form corresponding to the natural language utterance; and
training a generative artificial intelligence model with at least the set of long context training examples to generate a trained generative artificial intelligence model.

15. The non-transitory computer-readable media of claim 14, wherein the database schema of the selected training example is extended by the sampling and the combining until a combined context length of the prompt and the gold logical form is substantially close to but not exceeding a predefined context length.

16. The non-transitory computer-readable media of claim 15, wherein the predefined context length is fixed for each training example selected from the training dataset.

17. The non-transitory computer-readable media of claim 15, wherein the predefined context length is randomly sampled from a list of context length values for each training example selected from the training dataset.

18. The non-transitory computer-readable media of claim 14, wherein the sampled one or more tables are combined with the one or more tables in the database schema to generate a list of tables, and the tables in the list of tables are randomly shuffled to generate the long context database schema.

19. The non-transitory computer-readable media of claim 14, further comprising:
receiving an input from a user, the input comprising a natural language component;
converting the input into a prompt, wherein the prompt comprises an instruction, a database schema associated with the natural language component, and an utterance associated with the natural language component;
transmitting the prompt to the trained generative artificial intelligence model;
receiving, from the trained generative artificial intelligence model, a logical form corresponding to the natural language utterance based at least in part on the prompt;
executing the logical form on a database to obtain a query result; and
providing the query result to the user.

20. The non-transitory computer-readable media of claim 14, wherein the iterative process further comprises selecting the training example from the training dataset, and wherein the generative artificial intelligence model is trained with the set of long context training examples and the training examples from the training dataset.
